(19) United States
(12) Patent Application Publication
(10) Pub. No.: US 2008/0249767 A1
(43) Pub. Date: Oct. 9, 2008

(54) METHOD AND SYSTEM FOR REDUCING FRAME ERASURE RELATED ERROR PROPAGATION IN PREDICTIVE SPEECH PARAMETER CODING

(76) Inventor: Ali Erdem Ertan, Dallas, TX (US)

Correspondence Address: TEXAS INSTRUMENTS INCORPORATED, P O BOX 655474, M/S 3999, DALLAS, TX, 75265, US

(21) Appl. No.: 12/062,767

(22) Filed: Apr. 4, 2008

Related U.S. Application Data
(60) Provisional application No. 60/910,308, filed on Apr. 5, 2007.

(51) Int. Cl. G10L 19/04

(52) U.S. Cl. 704/219

(57) ABSTRACT

Predictive encoding methods, predictive encoders, and digital systems are provided that encode input frames by computing quantized predictive frame parameters for an input frame, recomputing the quantized predictive frame parameters wherein a previous frame is assumed to be erased and frame erasure concealment is used, and encoding the input frame based on the results of the computing and the recomputing. In embodiments of these methods, encoders, and digital systems, two phase codebook search techniques used in the encoding process are provided that compute the predictive parameters in the first phase, and the predictive parameters assuming the prior frame is erased in the second phase. In the second phase, a frame erasure concealment technique is used in the computation of the predictive parameters.

### CROSS REFERENCE TO RELATED APPLICATIONS

The present application claims priority to U.S. Provisional Patent Application No. 60/910,308, filed on Apr. 5, 2007, entitled “CELP System and Method” which is incorporated by reference.

### BACKGROUND OF THE INVENTION

The performance of digital speech systems using low bit rates has become increasingly important with current and foreseeable digital communications. Both dedicated channel and packetized voice-over-internet protocol (VoIP) transmission benefit from compression of speech signals. Linear prediction (LP) digital speech coding is one of the widely used techniques for parameter quantization in speech coding applications. This predictive coding method removes the correlation between the parameters in adjacent frames, and thus allows more accurate quantization at same bit-rate than non-predictive quantization methods. Predictive coding is especially useful for stationary voiced segments as parameters of adjacent frames have large correlations. In addition, the human ear is more sensitive to small changes in stationary signals, and predictive coding allows more efficient encoding of these small changes.

The predictive coding approach to speech compression models the vocal tract as a time-varying filter and a time-varying excitation of the filter to mimic human speech. Linear prediction analysis determines LP coefficients a(j), j=1, 2, . . . , M, for an input frame of digital speech samples {s(n)} by setting

r(n)=s(n)−Σ_{M≧j≧1}a(j)s(n−j) (0)

and minimizing Σ_{frame} r(n)². Typically, M, the order of the linear prediction filter, is taken to be about 8-16; the sampling rate to form the samples s(n) is typically taken to be 8 or 16 kHz; and the number of samples {s(n)} in a frame is often 80 or 160 for the 8 kHz sampling rate or 160 or 320 for the 16 kHz sampling rate. Various windowing operations may be applied to the samples of the input speech frame. The name “linear prediction” arises from the interpretation of the residual r(n)=s(n)−Σ_{M≧j≧1} a(j)s(n−j) as the error in predicting s(n) by a linear combination of preceding speech samples Σ_{M≧j≧1} a(j)s(n−j), i.e., a linear autoregression. Thus, minimizing Σ_{frame}r(n)² yields the {a(j)} which furnish the best linear prediction. The coefficients {a(j)} may be converted to line spectral frequencies (LSFs) or immittance spectrum pairs (ISPs) for vector quantization plus transmission and/or storage.

The {r(n)} form the LP residual for the frame, and ideally the LP residual would be the excitation for the synthesis filter 1/A(z) where A(z) is the transfer function of equation (0); that is, equation (0) is a convolution which corresponds to multiplication in the z-domain: R(z)=A(z)S(z), so S(z)=R(z)/A(z). Of course, the LP residual is not available at the decoder; thus the task of the encoder is to represent the LP residual so that the decoder can generate an excitation for the LP synthesis filter. Indeed, from input encoded (quantized) parameters, the decoder generates a filter estimate, Â(z), plus an estimate of the residual to use as an excitation, E(z), and thereby estimates the speech frame by Ŝ(z)=E(z)/Â(z). Physiologically, for voiced frames, the excitation roughly has the form of a series of pulses at the pitch frequency, and for unvoiced frames the excitation roughly has the form of white noise.

For speech compression, the predictive coding approach basically quantizes various parameters and only transmits/stores updates or codebook entries for these quantized parameters with respect to their values in the previous frame. A receiver regenerates the speech with the same perceptual characteristics as the input speech. Periodic updating of the quantized items requires fewer bits than direct representation of the speech signal, so a reasonable LP encoder can operate at bits rates as low as 2-3 kb/s (kilobits per second).

For example, the Adaptive Multirate Wideband (AMR-WB) encoding standard with available bit rates ranging from 6.6 kb/s up to 23.85 kb/s uses LP analysis with codebook excitation (CELP) to compress speech. An adaptive-codebook contribution provides periodicity in the excitation and is the product of a gain, g_{P}, multiplied by v(n), the excitation of the prior frame translated by the pitch lag of the current frame and interpolated to fit the current frame. An algebraic codebook contribution approximates the difference between the actual residual and the adaptive codebook contribution with a multiple-pulse vector (also known as an innovation sequence), c(n), multiplied by a gain, g_{C}. The number of pulses depends on the bit rate. That is, the excitation is u(n)=g_{P} v(n)+g_{C} c(n) where v(n) comes from the prior (decoded) frame, and g_{P}, g_{C}, and c(n) come from the transmitted parameters for the current frame. The speech synthesized from the excitation is then post filtered to mask noise. Post filtering essentially involves three successive filters: a short-term filter, a long-term filter, and a tilt compensation filter. The short-term filter emphasizes formants; the long-term filter emphasizes periodicity, and the tilt compensation filter compensates for the spectral tilt typical of the short-term filter.

While predictive coding is one of the widely used techniques for parameter quantization in speech coding applications, any error that occurs in one frame propagates into subsequent frames. In particular, for VoIP, the loss or delay of packets or other corruption can lead to erased frames. There are a number of techniques to combat error propagation including: (1) using a moving average (MA) filter that approximates the IIR filter which limits the error propagation to only a small number of frames (equal to the MA filter order); (2) reducing the prediction coefficient artificially and designing the quantizer accordingly so that an error decays faster in subsequent frames; and (3) using switched-predictive quantization (or safety-net quantization) techniques in which two different codebooks with two different predictors are used and one of the predictors is chosen small (or zero in the case of safety-net quantization) so that the error propagation is limited to the frames that are encoded with strong prediction.

### SUMMARY OF THE INVENTION

Embodiments of the invention provide methods and systems for reducing error propagation due to frame erasure in predictive coding of speech parameters. More specifically, embodiments of the invention provide codebook search techniques that reduce the distortion in decoded parameters when a frame erasure occurs in the prior frame. Some embodiments of the invention also provide a prediction coefficient initialization procedure for training prediction matrices and codebooks that takes the propagating distortion due to a frame erasure into account.

### BRIEF DESCRIPTION OF THE DRAWINGS

Particular embodiments in accordance with the invention will now be described, by way of example only, and with reference to the accompanying drawings:

FIG. 1 shows a block diagram of a speech encoder in accordance with one or more embodiments of the invention;

FIGS. 2 and 4 show flow diagrams of methods in accordance with one or more embodiments of the invention;

FIGS. 3 and 5 show block diagrams of predictive encoders in accordance with one or more embodiments of the invention;

FIG. 6 shows a block diagram of a predictive decoder in accordance with one or more embodiments of the invention; and

FIG. 7 shows an illustrative digital system in accordance with one or more embodiments.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein. Further, while embodiments of the invention may be described for LSFs (or ISFs) herein, one of ordinary skill in the art will know that the same quantization techniques may be used for immitance spectral frequencies (ISFs) (or LSFs) without modification as LSFs and ISFs have similar statistical characteristics.

In general, embodiments of the invention provide for the reduction of error propagation due to frame erasure in predictive coding of speech parameters. More specifically, predictive encoding methods and predictive encoders are provided which use a combination of predictive parameters and predictive parameters under the presumption of previous frame erasure. That is, two phase codebook search techniques used in the encoding process are provided that compute the predictive parameters in the first phase and the predictive parameters assuming the prior frame is erased in the second phase. In the second phase, a frame erasure concealment technique that is also used in the decoder when the encoded predictive parameters are not received is used in the computation of the predictive parameters. In addition, in some embodiments of the invention, methods for frame erasure predictor training in predictive quantization are provided that minimize both the error-free distortion and the erased-frame distortion.

In one or more embodiments of the invention, the encoders perform coding using digital signal processors (DSPs), general purpose programmable processors, application specific circuitry, and/or systems on a chip such as both a DSP and RISC processor on the same integrated circuit. Codebooks may be stored in memory at both the encoder and decoder, and a stored program in an onboard or external ROM, flash EEPROM, or ferroelectric RAM for a DSP or programmable processor may perform the signal processing. Analog-to-digital converters and digital-to-analog converters provide coupling to analog domains, and modulators and demodulators (plus antennas for air interfaces) provide coupling for transmission waveforms. The encoded speech may be packetized and transmitted over networks such as the Internet to another system that decodes the speech.

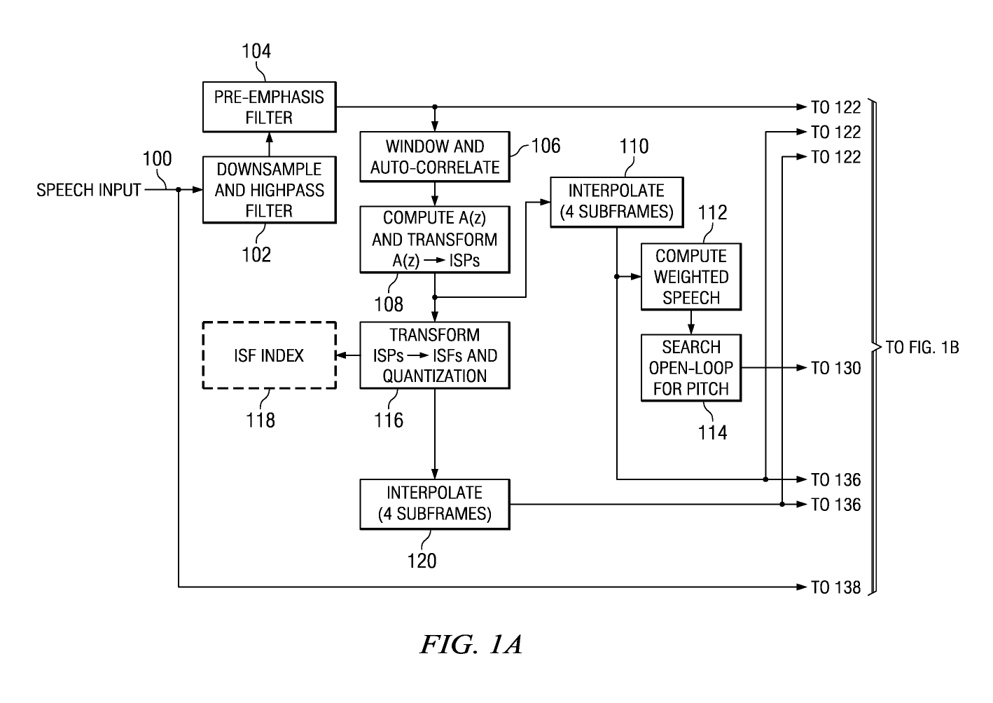

FIG. 1 is a block diagram of a speech encoder in accordance with one or more embodiments of the invention. More specifically, FIG. 1 shows the overall architecture of an AMR-WB speech encoder. The encoder receives speech input (100), which may be in analog or digital form. If in analog form, the input speech is then digitally sampled (not shown) to convert it into digital form. The speech input (100) is then down sampled as necessary and highpass filtered (102) and pre-emphasis filtered (104). The filtered speech is windowed and autocorrelated (106) and transformed first into LPC filter coefficients (in the A(z) form) and then into ISPs (108).

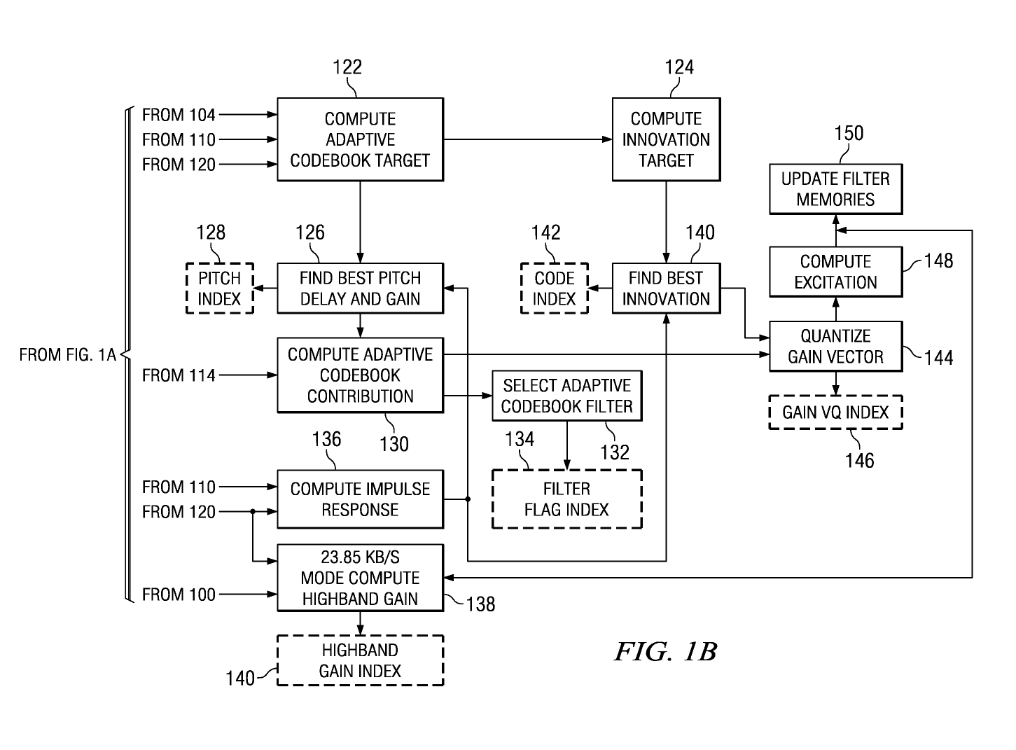

The ISPs are interpolated (110) to yield ISP's in (e.g., four) subframes. The subframes are filtered with the perceptual weighting filter (112) and searched in an open-loop fashion to determine their pitch (114). The ISPs are also further transformed into immitance spectral frequencies (ISFs) and quantized (116). In one or more embodiments of the invention, the ISFs are quantized in accordance with predictive coding techniques that provide for the reduction of error propagation due to frame erasure as described below in reference to FIGS. 2-5. The quantized ISFs are stored in an ISF index (118) and interpolated (120) to yield quantized ISFs in (e.g., four) subframes.

The speech that was emphasis-filtered (104), the interpolated ISPs, and the interpolated, quantized ISFs are employed to compute an adaptive codebook target (122), which is then employed to compute an innovation target (124). The adaptive codebook target is also used, among other things, to find a best pitch delay and gain (126), which is stored in a pitch index (128).

The pitch that was determined by open-loop search (114) is employed to compute an adaptive codebook contribution (130), which is then used to select and adaptive codebook filter (132), which is then in turn stored in a filter flag index (134).

The interpolated ISPs and the interpolated, quantized ISFs are employed to compute an impulse response (136). The interpolated, quantized ISFs, along with the unfiltered digitized input speech (100), are also used to compute highband gain for the 23.85 kb/s mode (138).

The computed innovation target and the computed impulse response are used to find a best innovation (140), which is then stored in a code index (142). The best innovation and the adaptive codebook contribution are used to form a gain vector that is quantized (144) in a Vector Quantizer (VQ) and stored in a gain VQ index (146). The gain VQ is also used to compute an excitation (148), which is finally used to update filter memories (150).

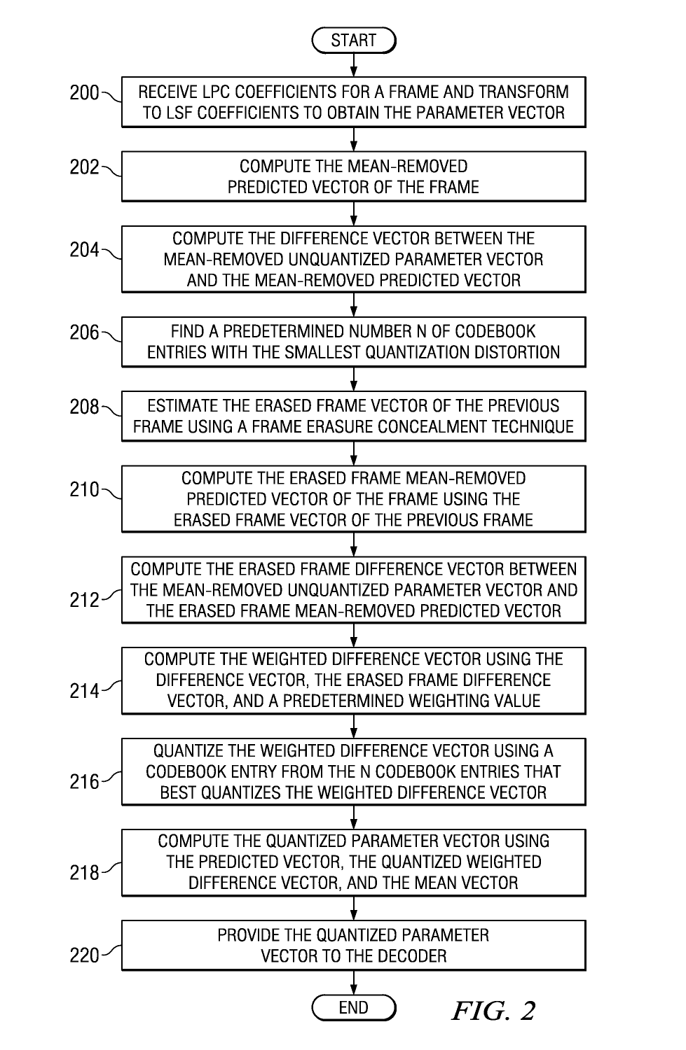

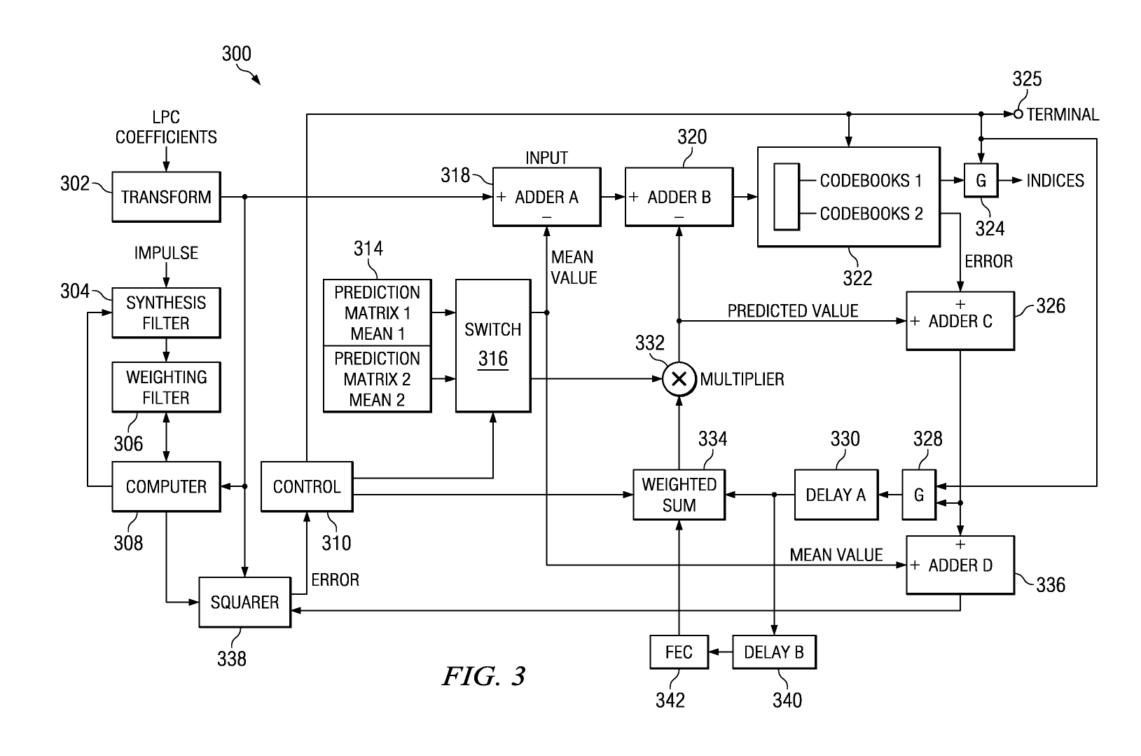

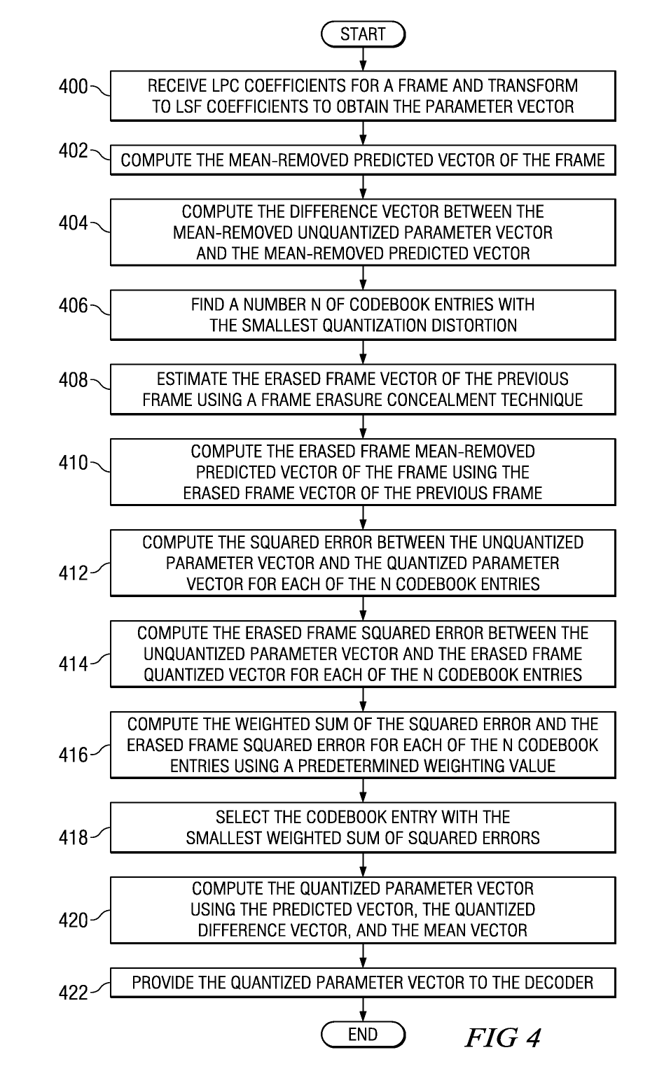

FIGS. 3 and 5 show block diagrams of the architectures of predictive encoders in accordance with one or more embodiments of the invention and FIGS. 2 and 4 show methods for predictive encoding in accordance with one or more embodiments of the invention. More specifically, these figures illustrate techniques for predictive quantization that reduce error propagation due to frame erasure. Predictive quantization can be applied to almost all parameters in speech coding applications including linear prediction coefficients (LPC), gain, pitch, speech/residual harmonics, etc. In this technique, the mean of the parameter vector, μₓ, is first subtracted from the quantized parameter vector in the prior frame (k−1st frame), \hat{x}^{k-1}, and then, the current frame (kth frame) is predicted from the prior frame as:

\check{x}^{k}=A(\hat{x}^{k-1}−μₓ), (1)

where A is the prediction matrix and \check{x}^{k} is the mean-removed predicted vector of the current frame. When the correlation among the elements of the parameter vector is zero such as in line spectral frequencies (LSF) or immitance spectral frequencies (ISF), A is a diagonal matrix. Then, the difference vector d^{k} between the mean-removed predicted vector of the current frame and the mean-removed unquantized parameter vector x^{k} is calculated as

d^{k}=(x^{k}−μₓ)−\check{x}^{k}. (2)

This difference vector is then quantized and sent to the decoder.

In the decoder, the current frame's parameter vector is first predicted using (1), and then, the quantized difference vector and the mean vector are added to find the quantized parameter vector, \hat{x}^{k}

\hat{x}^{k}=\check{x}^{k}+\hat{d}^{k}+μₓ, (3)

where \hat{d}^{k} is the quantized version of the difference vector calculated with (2).

In a typical quantization system, A and μₓ are usually obtained by a training procedure using a set of vectors. μₓ is obtained as the mean of the vectors in this set, and A is chosen to minimize the summation of squared d^{k} in all frames. The difference vector d^{k} may be coded with any quantization technique (e.g., scalar and vector quantization) that is designed to optimally quantize difference vectors.

Without loss of generality, if the mean vector in (1) is assumed to be zero and A is a diagonal matrix, equation (1) is simply an IIR filtering with zero input that gives \check{x}. For this reason, when the quantized difference vector \hat{d}^{k} in the decoder is not equal to the one in the encoder (i.e., is corrupted) in the k^{th} frame because of a frame erasure or a bit-error, \hat{x}^{k} also becomes corrupted and the quantized parameter vectors in all of the subsequent frames will also be corrupted. To decrease the error propagation due to frame erasure, embodiments of the invention use two phase codebook search techniques in the encoder as are described below in relation to FIGS. 2-5.

FIG. 2 shows a flow diagram of a method for decreasing the error propagation due to frame erasure in accordance with one or more embodiments of the invention. Initially, the LPC coefficients for a frame k are received and transformed to LSF coefficients to obtain the parameter vector x^{k} (200). The first phase of the codebook search technique of this method is described in steps 202-206. In this first phase, the mean-removed predicted vector of the current frame \check{x}^{k} is computed using (1) (202), the difference vector d^{k} between the mean-removed predicted vector \check{x}^{k} and the mean-removed unquantized parameter vector x^{k}−μₓ is computed using (2) (204), and the codebook(s) are searched to find a predetermined number of entries, N, with the smallest quantization distortions (206). The quantization distortion calculated in this first phase is referred to as error-free quantization distortion. In one or more embodiments of the invention, the predetermined number of entries N is M as described below for multi-stage vector quantization. Further, in one or more embodiments of the invention, the value of N is 5. The selection of the value of N is discussed in more detail below.

In one or more embodiments of the invention, multi-stage vector quantization (MSVQ) is used to find the N entries. In MSVQ, multiple codebooks are used and a central quantized vector (i.e., the output vector) is obtained by adding a number of quantized vectors. The output vector is sometimes referred to as a “reconstructed” vector. Each vector used in the reconstruction is from a different codebook, each code book corresponding to a “stage” of the quantization process. Further, each codebook is designed especially for a stage of the search. An input vector is quantized with the first codebook, and the resulting error vector (i.e., difference vector) is quantized with the second codebook, etc. The set of vectors used in the reconstruction may be expressed as:

y^{(j}^{₀}^{,j}^{₁}^{, . . . j}^{ₛ₋₁}⁾=y₀^{(j}^{₁}⁾+y₁^{(j}^{₁}⁾+ . . . +yₛ₋₁^{(j}^{ₛ₋₁}⁾

where s is the number of stages and yₛ is the codebook for the sth stage. For example, for a three-dimensional input vector, such as x=(2,3,4), the reconstruction vectors for a two-stage search might be y₀=(1,2,3) and y₁=(1,1,1) (a perfect quantization and not always the case).

During MSVQ, the codebooks may be searched using a sub-optimal tree search algorithm, also known as an M-algorithm. At each stage, an M-best number of “best” code-vectors are passed from one stage to the next. The “best” code-vectors are selected in terms of minimum distortion. In the prior art, the search continues until the final stage, where only one best code-vector is determined. In one or more embodiments of the invention, N best vectors are chosen in the final stage.

Returning to FIG. 2, the second phase of the codebook search technique of this method is described in steps 208-216. In this second phase, (1) and (2) are recomputed assuming that the prior frame x^{k-1} is corrupted, i.e., using (4) and (5) below. First, the erased frame vector of the previous frame [symbol] is estimated using the frame erasure concealment technique of the decoder (208). That is, the vector of the previous frame is computed as if the quantized difference vector \hat{d}^{k-1} of that frame is corrupted. Frame erasure concealment techniques are known in the art and any such technique may be used in embodiments of the invention.

Then, the erased frame mean-removed predicted vector of the current frame [symbol] is computed using the erased frame vector [symbol] (210). More specifically, the erased frame mean-removed predicted vector [symbol] is computed as

[symbol]

=A( [symbol] −μₓ) (4)

The erased frame difference vector \tilde{d}^{k} between the mean-removed unquantized parameter vector x^{k}−μₓ and the erased frame mean-removed predicted vector [symbol] is then computed (212) as

\tilde{d}^{k}=(x^{k}−μₓ)− [symbol] (5)

Although the erased frame difference vector \tilde{d}^{k} is not directly quantized, the quantization distortion had \tilde{d}^{k} been quantized is referred as the erased-frame quantization distortion herein.

Once the erased frame difference vector \tilde{d}^{k} is computed, a weighted difference vector d̅^{k} is computed using the difference vector d^{k}, the erased frame difference vector \tilde{d}^{k}, and a predetermined weighting value α between 0 and 1 (214). More specifically, the weighted difference vector d̅^{k} is computed as

d̅^{k}=αd^{k}+(1−α)\tilde{d}^{k}. (6)

In one or more embodiments of the invention, the value of α is 0.5. The selection of the value of α is discussed in more detail below. The weighted difference vector d̅^{k} is then quantized using a codebook entry from the N codebook entries that best quantizes the vector (i.e., that quantizes the vector with the least distortion) (216). Finally, the quantized parameter vector \hat{x}^{k} is computed using the predicted vector \check{x}^{k}, the quantized weighted difference vector [symbol] , and the mean vector μₓ (218) and the quantized parameter vector \hat{x}^{k} is provided to the decoder (220). More specifically, the quantized parameter vector \hat{x}^{k} is computed as

\hat{x}^{k}=\check{x}^{k}+ [symbol] +μₓ.

Further, the quantized parameter vector \hat{x}^{k} is provided to the decoder in the form of indices into the codebooks.

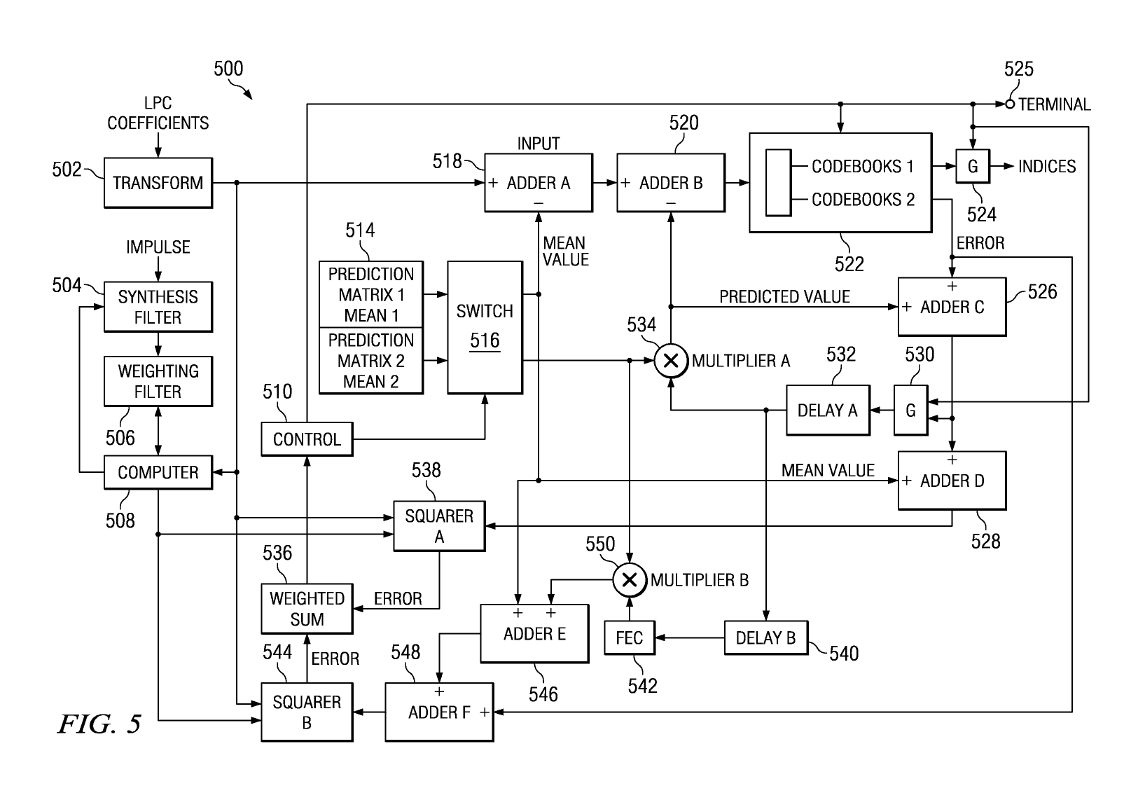

Before explaining how the parameters, i.e., the number of codebook entries N and the weighting value α, may be selected, it must be emphasized to avoid any confusion that the method of FIG. 2 (and the method of FIG. 4) is performed in the encoder. In the prior art, frame erasure concealment (FEC) was performed only in the decoder. In embodiments of the invention, FEC is used in the encoder to simulate what might happen in decoder if the previous frame is erased. Thus, as is explained in more detail below in reference to FIG. 6, although embodiments of the encoder use (4) for prediction and quantize (6) in the second phase, the decoder still uses (1) and (3) to obtain the final quantized parameter vector. This mismatch between the encoder and the decoder—but only in this second phase—allows a trade-off between clean-channel performance and frame-erasure performance. The selection of N in the first phase and a in the second phase determines the trade-off at the end. If N is set to the size of the entire codebook and α is set to zero, then the encoder is fully tuned for frame-erasure performance. However, if N is set to one or α is set to one, then the encoder is fully tuned for clean-channel performance. If N is to the size of entire codebook and α is set to 0.5, equal importance is given to both frame-erasure performance and clean-channel performance.

However, many choices of N and α increase error-free quantization distortion significantly and are unacceptable for most applications. Therefore, N is usually set to a small number to ensure that the codebook entries selected in the first phase result in a reasonable quantization performance. Selecting a small set of codebook entries in the first stage that best quantize the difference vector d^{k} and then selecting the codebook entry that best quantizes the weighted difference vector d̅^{k} in the second phase results in the selection of a codebook entry that significantly decreases the erased-frame quantization distortion that may occur because of a frame erasure in the prior frame while not significantly sacrificing the accuracy of error-free quantization. In addition, the selection of α determines how much error-free quantization accuracy is to be sacrificed to reduce the erased-frame distortion in case a frame erasure occurs. Moreover, α may be varied from frame to frame and selected to be closer to one when the parameter quantization needs to be as accurate as possible or to be closer to zero when more robustness is needed for frame-erasures.

Although the method of FIG. 2 (and FIG. 4) can be used in any application that uses predictive coding and is prone to frame erasures, N and α can be selected for speech applications such that the second phase does not affect the perceptual quality of the decoded speech despite the slight increase in error-free quantization distortion. It is well known that the human ear cannot perceive a difference between speech synthesized with unquantized parameters and that synthesized with quantized parameters when quantized parameters satisfy various constraints. These constraints can be summarized as follows:
The spectral distortion (SD) between the log-spectra of the quantized linear prediction (LPC) parameters and un-quantized LPC parameters is less than 1 dB.
The quantized fundamental frequency in a parametric coder is within 1 Bark distance of the un-quantized fundamental frequency.
The quantization noise between quantized speech/residual harmonics and un-quantized speech/residual harmonics in a parametric coder is masked with the encoded speech signal.
The quantized gain parameter in a parametric speech coder is sufficiently close to unquantized gain such that they both result in same loudness at output.

Thus, for speech coding applications, in the first phase, the codebook indices that satisfy these constraints are found, and then, in the second phase, the codebook entry that minimizes the erased-frame quantization distortion is selected. Although the weighting value α is set to zero in this case (i.e., frame-erasure performance is prioritized), all codebook indices searched in the second phase are perceptually equivalent to the un-coded parameter vector; therefore, it does not matter which one is selected for clean-channel performance. For example, in pitch period quantization, the quantization indices that are within 1 Bark distance of the unquantized pitch value are obtained in the first phase, and then, the quantization index that best represents (6) with α set to zero is found in the second phase. In this example, all of the quantization indices selected in the first phase result in perceptually equivalent encoding of the pitch period value; therefore, the decoded speech will be perceptually equivalent no matter which index is chosen.

These constraints can be easily satisfied for pitch period and gain parameters as the Bark distance and equivalent loudness can be calculated with low-complexity methods. In addition, these parameters are almost always quantized with non-uniform scalar quantizers. Therefore, it is always possible to first find the quantization index that is closest to the unquantized parameter, and then, search only the neighboring indices that satisfy the constraints given above. After those indices are found, the index that reduces the erased-frame quantization distortion is selected and sent to the decoder.

Using the two phase technique is more complex for LP coefficients. SD computation requires logarithmic calculations of frequency responses of LP coefficients for a large number of frequencies that are computationally very complex and not practical to do in a real-time application. In addition, even if SD computation for one vector is not complex, LP coefficients are usually encoded in the form of LSFs or ISFs with a very large number of bits (typically between 20 and 35), and therefore, computing SD for each codebook index is computationally prohibitive. However, Gardner and Rao, “Theoretical Analysis of the High-Rate Vector Quantization of LPC Parameters”, IEEE Tran. Speech and Audio Proc, 367 (1995), show that as coefficients of LSFs and ISFs are uncorrelated, a weighted Euclidian distance error metric can be used to approximate SD when weights are chosen as the diagonal entries of the sensitivity matrix of LSFs or ISFs (off-diagonal elements of this matrix is already zero, because coefficients of both LSF and ISF are uncorrelated).

In addition, for LSFs, U.S. Pat. No. 6,889,185 filed on Aug. 15, 1998, entitled “Quantization of Linear Prediction Coefficients Using Perceptual Weighting” also shows that human ear's frequency sensitivity can be incorporated into this weighting method by applying a Bark weighting filter to the signal before correlation coefficients are computed. Although this weighting technique was originally developed for LSFs, as p order ISF is actually p−1 order LSF and the last reflection coefficient of the LPC filter, the Bark weighted sensitivity matrix of ISFs can be approximated by the Bark weighted sensitivity matrix of p−1 order LSFs with the pth entry of the diagonal set to 1. Finally, a second order function is used to make a one to one mapping between the weighted Euclidian distance measure and SD. As the quantized LSF/ISF vector is perceptually equivalent to the unquantized LSF/ISF vector when SD is less than 1 dB, in the two phase code book search technique, the codebook indices that have a weighted distance measure less than a threshold that corresponds to an SD equal to 1 dB are found in the first phase, and then, the codebook index that minimizes the erased-frame quantization distortion is found in the second phase. In this case, the selected codebook entry is guaranteed to be perceptually equivalent to the unquantized vector and at the same time will decrease the erased-frame distortion in case the prior frame is erased.

In speech/residual harmonic coding, the quantization noise throughout the spectrum needs to be computed for each vector in the codebook and the vectors whose quantization noise is masked by the signal itself are selected in the first phase. In the second phase, the codebook index that best represents (6) is selected to minimize the erased frame quantization distortion without introducing any perceptually audible error-free distortion.

Overall this technique has low complexity: the additional complexity only comes from the second phase. Especially, when N is set to a small number or made adaptive similar to the speech specific setup described above, (6) is only searched within a small number of vectors, and therefore, the additional complexity is often almost negligible compared to the complexity of the entire quantization algorithm. For this reason, the method described above decreases the speech distortion in a speech coder because of a frame erasure with only a small increase in computational complexity.

FIG. 3 shows a block diagram of a predictive encoder in accordance with one or more embodiments of the invention. More specifically, the predictive encoder of FIG. 3 is an LSF encoder (300) with a switched predictive quantizer that reduces error propagation due to frame erasure using a two phase codebook search technique. In general, in a switched predictive quantizer, the vector of the current frame is predicted from the mean-removed quantized vector of the previous frame using a prediction matrix and a mean vector. Further, there is more than one prediction matrix/mean vector pair. In addition, more than one codebook set may be used where each codebook set is associated with one prediction matrix/mean vector pair. For each frame, the best prediction matrix/mean vector/codebook set is chosen by processing the parameters of the frame with each set in turn and comparing the measured errors from each processing cycle; that is, the first prediction matrix/mean vector/codebook set is switched in, the parameters are processed, and the measured error determined; then the second set is switched in, etc. When the parameters have been processed using all of the sets, the measured errors are compared and the indices for the set with the minimum measured error are provided to the decoder.

In the encoder of FIG. 3, two prediction matrix/mean vector/codebook sets are used: the first set is prediction matrix 1, mean vector 1, and codebooks 1 and the second set is prediction matrix 2, mean vector 2, and codebooks 2. Further, the prediction matrices and codebooks may be trained as described below. In the encoder, the LPC coefficients for the current frame k are transformed by the transformer (302) to LSF coefficients of the LSF vectors. In the first phase of the two phase codebook search technique, the control (310) first applies control signals to switch in via switch (316) prediction matrix 1 and mean vector 1 from encoder storage (314) and to cause the first set of codebooks (i.e., codebooks 1) to be used in the quantizer (322). The resulting LSF vector xk from the transformer (302) is subtracted in adder A (318) by the selected mean vector μₓ (i.e., mean 1) and the resulting mean-removed input vector is subtracted in adder B (320) by a predicted value \check{x}^{k} for the current frame k. The predicted value \check{x}^{k} is the mean-removed quantized vector for the previous frame k−1 (i.e., \hat{x}^{k-1}-μₓ) multiplied by a known prediction matrix A (i.e., prediction matrix 1) at the multiplier (332). The process for supplying the mean-removed quantized vector for the previous frame to the multiplier (332) is described below.

The output of adder B (320) is a difference vector d^{k} for the current frame k. This difference vector d^{k} is applied to the multi-stage vector quantizer (MSVQ) (322). That is, the control (310) causes the quantizer (322) to compute the difference between the first entry in codebooks 1 and the difference vector d^{k}. The output of the quantizer (322) is the quantized difference vector \hat{d}^{k} (i.e., error). The predicted value \check{x}^{k} from the multiplier (332) is added to the quantized difference vector \hat{d}^{k} from the quantizer (322) at adder C (326) to produce a quantized mean-removed vector. The quantized mean-removed vector from adder C (326) is gated (328) to the frame delay A (330) so as to provide the mean-removed quantized vector for the previous frame k−1, i.e., \hat{x}^{k-1}−μₓ, to the weighted sum (334).

The output of the frame delay A (330), i.e., the mean-removed quantized vector for the previous frame k−1, is also provided to the frame delay B (340), so as to provide the mean-removed quantized vector for the prior frame k−2, i.e., \hat{x}^{k-2}−μₓ, to the frame erased concealment (FEC) (342). The output of the FEC (342) is the erased frame vector for the previous frame k−1, i.e., [symbol] The erased frame vector from the FEC (342) is provided to the weighted sum (334). The FEC (342) is explained in more detail below in the description of the second phase of the codebook search.

In the first phase, the weighted sum (334) provides the mean-removed quantized vector for the previous frame k−1, i.e., \hat{x}^{k-1}−μₓ, to the multiplier (332). More specifically, the weighted sum (334) performs a weighted summation of the outputs from frame delay A (330) and the FEC (342) as is explained in more detail below in the description of the second phase of the codebook search. In the first phase, the weighted value used by the weighted sum (334) is set by the control (310) such that the output from the FEC contributes nothing to the weighted summation.

The quantized mean-removed vector from adder C (326) is also added at adder D (328) to the selected mean vector μₓ (i.e., mean 1) to get the quantized vector \hat{x}^{k}. The squared error for each dimension is determined at the squarer (338). The weighted squared error between the input vector xᵢ and the delayed quantized vector \hat{x}ᵢ is stored at the control (310). The determination of the weighted squared error (i.e., measured error) is discussed in more detail below. The above process is repeated for each codebook entry in codebooks 1 (e.g., in the second execution of the process, the quantizer (322) computes the difference between the difference vector d^{k} and the second entry in codebooks 1, etc.) with the resulting weighted squared error for each codebook entry stored at the control (310). Once the process has been repeated for all codebook entries in codebooks 1, the control (310) compares the stored measured errors for the codebook entries and identifies a predetermined number N of codebook entries with the minimum error (i.e., minimum distortion) for codebooks 1. In one or more embodiments of the invention, the predetermined number of entries N is M as described above for multi-stage vector quantization. Further, in one or more embodiments of the invention, the value of N is 5.

The control (310) then applies control signals to switch in via the switch (316) prediction matrix 2, mean vector 2, and to cause the second set of codebooks (i.e., codebooks 2) to be used to likewise measure the weighted squared error for each codebook entry of codebooks 2 as described above. Once the control (310) has identified the predetermined number N of codebook entries with the minimum error for codebooks 2, in one or more embodiments of the invention, the controller (310) compares the measured errors of the two selected sets of codebook entries to pick the set that quantizes the difference vector d^{k} with the least distortion to be used in phase two of the codebook search technique. In other embodiments of the invention, the selected N codebook entries from both codebooks may be searched in the second phase.

In the second phase of the two phase codebook search technique, the LPC coefficients for the frame are quantized again with the assumption that the previous frame is erased. Further, in this second phase, the weighted difference vector d̅^{k} of (6) above is equivalently computed as

d̅^{k}=(x^{k}−μₓ)−A[α(\hat{x}^{k-1}−μₓ)+(1−α)( [symbol] −μₓ)]. (7)

In the second phase, the control (310) first applies control signals to cause the set of codebooks that include the predetermined number N of codebook entries selected in the first phase to be used in the quantizer (322) and to switch in via switch (316) the prediction matrix and mean vector from encoder storage (314) that is associated with the set of codebooks. For purposes of the description, the selection of entries from codebook 1 is assumed. The resulting LSF vector x^{k} from the transformer (302) is subtracted in adder A (318) by the selected mean vector μₓ (i.e., mean 1) and the resulting mean-removed input vector is subtracted in adder B (320) by a predicted value [symbol] for the current frame k. The predicted value [symbol] , i.e., the weighted sum of the erased frame mean-removed predicted vector and the clean-channel mean-removed predicted vector, is the output of the weighted sum (334) multiplied by a known prediction matrix A (i.e., prediction matrix 1) at the multiplier (332). The output of the weighted sum (334) supplied to the multiplier (332) is described below.

The output of adder B (320) is a weighted difference vector d̅^{k} for the current frame k. This weighted difference vector d̅^{k} is applied to the multi-stage vector quantizer (MSVQ) (322). That is, the control (310) causes the quantizer (322) to compute the difference between the first entry of the predetermined number N codebook entries and the weighted difference vector d̅^{k}. The output of the quantizer (322) is the quantized weighted difference vector [symbol] (i.e., error). The predicted value [symbol] from the multiplier (332) is added to the quantized weighted difference vector [symbol] from the quantizer (322) at adder C (326) to produce a quantized mean-removed vector (i.e., the weighed sum of the erased frame mean-removed vector and the clean-channel mean-removed vector). The quantized mean-removed vector from adder C (326) is gated (328) to the frame delay A (330) so as to provide the mean-removed quantized vector for the previous frame k−1, i.e., \hat{x}^{k-1}−μₓ, to the weighted sum (334).

The output of the frame delay A (330), i.e., the mean-removed quantized vector for the previous frame k−1, is also provided to the frame delay B (340), so as to provide the mean-removed quantized vector for the prior frame k−2, i.e., \hat{x}^{k-2}−μₓ, to the frame erased concealment (FEC) (342). The output of the FEC (342) is the erased frame vector for the previous frame k−1, i.e., [symbol] More specifically, the FEC (342) estimates the erased frame vector for the previous frame k−1 using the frame erasure concealment technique of the decoder. That is, the vector of the previous frame is computed as if the quantized difference vector \hat{d}^{k-1} for that frame is corrupted. Frame erasure concealment techniques are known in the art and any such technique may be used in embodiments of the invention.

The erased frame vector for the previous frame from the FEC (342) is provided to the weighted sum (334). In the second phase, the weighted sum (334) performs a weighted summation of the outputs from frame delay A (330) and the FEC (342). More specifically, the output of the weighted sum is

α(\hat{x}^{k-1}−μₓ)+(1−α)( [symbol] −μₓ),

where α is a predetermined weighting value set by the control (310) for the second phase. This predetermined weighting value may be selected as previously described above.

The quantized mean-removed vector from adder C (326) is also added at adder D (328) to the selected mean vector μₓ (i.e., mean 1) to get the quantized vector \hat{x}^{k}. The squared error for each dimension is determined at the squarer (338). The weighted squared error between the input vector xᵢ and the delayed quantized vector \hat{x}ᵢ is stored at the control (310). The determination of the weighted squared error (i.e., measured error) is discussed in more detail below. The above phase two process is repeated for each codebook entry in the N codebook entries (e.g., in the second execution of the phase two process, the quantizer (322) computes the difference between the weighted difference vector d̅^{k} and the second entry in the N codebook entries, etc.) with the resulting weighted squared error for each codebook entry stored at the control (310). Once the process has been repeated for all N codebook entries, the control (310) compares the stored measured errors for the N codebook entries and identifies the codebook entry with the minimum error. The control (310) then causes the set of indices for this codebook entry to be gated (324) out of the encoder as an encoded transmission of indices and a bit is sent out at the terminal (325) from the control (310) indicating from which prediction matrix/codebooks the indices were sent (i.e., codebooks 1 with mean vector 1 and prediction matrix 1 or codebook 2 with mean vector 2 and prediction matrix 2).

To determine the weighted squared error in either phase one or phase two of the codebook search technique, a weighting wᵢ is applied to the squared error at the squarer (338). The weighting wᵢ is an optimal LSF weight for unweighted spectral distortion and may be determined as described in U.S. Pat. No. 6,122,608 filed on Aug. 15, 1998, entitled “Method for Switched Predictive Quantization” which is incorporated by reference. The weighted output ε (i.e., the weighted squared error) from the squarer (338) is

ε=Σᵢwᵢ(xᵢ−\hat{x}ᵢ)²

The computer (308) is programmed as described in the aforementioned U.S. Pat. No. 6,122,608 to compute the LSF weights wᵢ using the LPC synthesis filter (304) and the perceptual weighting filter (306). The computed weight value from the computer (308) is then applied at the squarer (338) to determine the weighted squared error.

FIG. 4 shows a flow diagram of a method for decreasing the error propagation due to frame erasure in accordance with one or more embodiments of the invention. In the method of FIG. 4, the first phase of the codebook search technique is essentially the same as the first phase of the codebook search technique of the method of FIG. 2. That is, in the first phase, the N best codebook entries are found, i.e., the ones that give the lowest quantization distortion. To find the codebook entries with the lowest quantization distortion, the following squared error term ε is minimized which is equivalent to minimizing the quantization distortion:

ε=Σᵢwᵢ(xᵢ−\hat{x}ᵢ)₂=Σᵢwᵢ(dᵢ−\hat{d}ᵢ)² (8)

As can be seen from equation above, finding the difference between the unquantized parameter vector xᵢ and the quantized parameter vector \hat{x}ᵢ is the same as finding the difference between the unquantized difference vector dᵢ and the quantized difference vector \hat{d}ᵢ. In summary, in the first phase, the N \hat{d}ᵢ's are found that provide the smallest ε.

Further, in the first phase of the method of FIG. 4, N may be different for each frame. That is, for each frame, each of the N codebook entries are selected such that the quantized predictive parameters are perceptually equivalent to unquantized parameters for the frame. More specifically, in the last stage of MSVQ, the weighted squared error for each selected codebook entry is compared to a predetermined threshold and may be selected for searching in the second phase if the weighted squared error is less than this predetermined threshold. Further, the maximum number of codebook entries that may be selected from a codebook has an upper bound of M as defined above. In one or more embodiments of the invention, M is five. Also, in one or more embodiments of the invention, the predetermined threshold is 67,000 for wideband speech signals and 62,000 for narrowband speech signals.

However, the second phase of codebook search technique of the method of FIG. 4, a different squared error term ε̅ is used, i.e., the weighted sum of the squared error of (8) and the squared error when the predicted vector \check{x}^{k} is replaced by the erased-frame predicted vector [symbol] :

ε̅=αΣᵢwᵢ(xᵢ−\hat{x}ᵢ)²+(1−α)Σᵢwᵢ(xᵢ− [symbol] )^{x} (9)

Therefore, in the second phase of codebook search technique of the method of FIG. 4, the N codebook entries identified in the first phase are searched for the codebook entry that has the minimum weighted sum squared error ε̅.

Returning to FIG. 4, in the method, steps 400-410 are the same as steps 200-210 of the method of FIG. 2 with the previously mentioned exception regarding selection of the N codebook entries. Once the erased frame mean-removed predicted vector of the current frame [symbol] is computed (410), the squared error between the unquantized parameter vector xᵢ and the quantized parameter vector \hat{x}ᵢ (i.e., (xᵢ−\hat{x}ᵢ)²) for each of the N codebook entries is computed (412). Then, the erased frame squared error between the unquantized parameter vector xᵢ and the erased frame quantized parameter vector [symbol] (i.e., (xᵢ− [symbol] )²) for each of the N codebook entries is computed (414). The weighted sum of the squared error and the erased frame squared error ε̅,

αΣᵢwᵢ(xᵢ−\hat{x}ᵢ)²+(1−α)Σᵢwᵢ(xᵢ− [symbol] )

is then computed for each of the N codebook entries using a predetermined weighting value α between 0 and 1 (416). The selection of the value of α is discussed in more detail above.

The codebook entry of the N codebook entries with the smallest weighted sum of squared errors ε̅ is subsequently selected (418). The difference vector d^{k} is then quantized using the selected codebook entry (not shown). Finally, the quantized parameter vector \hat{x}^{k} is computed using the predicted vector \check{x}^{k}, the quantized difference vector \hat{d}^{k}, and the mean vector μₓ(420) and the quantized parameter vector \hat{x}^{k} is provided to the decoder (422). More specifically, the quantized parameter vector \hat{x}^{k} is computed as

\hat{x}^{k}=\check{x}^{k}+\hat{d}^{k}+μₓ.

Further, the quantized parameter vector \hat{x}^{k} is provided to the decoder in the form of indices into the codebooks.

FIG. 5 shows a block diagram of a predictive encoder in accordance with one or more embodiments of the invention. More specifically, the predictive encoder of FIG. 5 is an LSF encoder (500) with a switched predictive quantizer that reduces error propagation due to frame erasure using a two phase codebook search technique. In the predictive encoder of FIG. 5, the first phase of the codebook search technique is similar to the first phase of the codebook search technique of the predictive encoder of FIG. 3 with the exception that the number of selected codebook entries N may vary with each frame. That is (as is explained in more detail below), in the first phase, the N best codebook entries are found that provide the smallest the squared error term ε of (8) and are less than a predetermined threshold. However, the second phase of the codebook search technique of the encoder of FIG. 5 searches the selected codebook entries for the codebook entry that has the minimum weighted sum squared error ε̅ of (9).

In the encoder of FIG. 5, two prediction matrix/mean vector/codebook sets are used: the first set is prediction matrix 1, mean vector 1, and codebooks 1 and the second set is prediction matrix 2, mean vector 2, and codebooks 2. Further, the prediction matrices and codebooks may be trained as described below. In the encoder, the LPC coefficients for the current frame k are transformed by the transformer (502) to LSF coefficients of the LSF vectors. In the first phase of the two phase codebook search technique, the control (510) first applies control signals to switch in via the switch (516) prediction matrix 1 and mean vector 1 from encoder storage (514) and to cause the first set of codebooks (i.e., codebooks 1) to be used in the quantizer (522). The resulting LSF vector x^{k} from the transformer (502) is subtracted in adder A (518) by the selected mean vector μₓ (i.e., mean 1) and the resulting mean-removed input vector is subtracted in adder B (520) by a predicted value \check{x}^{k} for the current frame k. The predicted value \check{x}^{k} is the mean-removed quantized vector for the previous frame k−1 (i.e., \hat{x}^{k-1}−μₓ) multiplied by a known prediction matrix A (i.e., prediction matrix 1) at multiplier A (534). The process for supplying the mean-removed quantized vector for the previous frame to multiplier A (534) is described below.

The output of adder B (520) is a difference vector d^{k} for the current frame k. This difference vector d^{k} is applied to the multi-stage vector quantizer (MSVQ) (522). That is, the control (510) causes the quantizer (522) to compute the difference between the first entry in codebooks 1 and the difference vector d^{k}. The output of the quantizer (522) is the quantized difference vector \hat{d}^{k} (i.e., error). The predicted value \check{x}^{k} from multiplier A (534) is added to the quantized difference vector \hat{d}^{k} from the quantizer (522) at adder C (526) to produce a quantized mean-removed vector. The quantized mean-removed vector from adder C (526) is gated (530) to the frame delay A (532) so as to provide the mean-removed quantized vector for the previous frame k−1, i.e., \hat{x}^{k-1}−μₓ, to multiplier A (534).

The quantized mean-removed vector from adder C (326) is also added at adder D (328) to the selected mean vector μₓ (i.e., mean 1) to get the quantized vector \hat{x}^{k}. Then, the weighted squared error for the difference between the input vector xᵢ (from the transformer (502)) and the quantized vector \hat{x}ᵢ is determined at squarer A (538). To determine the weighted squared error, a weighting wᵢ is applied to the squared error at squarer A (538). The weighting wᵢ is an optimal LSF weight for unweighted spectral distortion and may be determined as previously described above. The weighted output ε (i.e., the weighted squared error) from squarer A (538) is

ε=Σᵢwᵢ(xᵢ−\hat{x}ᵢ)².

The computer (508) is programmed as previously described to compute the LSF weights wᵢ using the LPC synthesis filter (504) and the perceptual weighting filter (506). The computed weight value from the computer (508) is then applied at squarer A (538) to determine the weighted squared error.

The output of the frame delay A (532), i.e., the mean-removed quantized vector for the previous frame k−1, is also provided to the frame delay B (540), so as to provide the mean-removed quantized vector for the prior frame k−2, i.e., \hat{x}^{k-2}−μₓ, to the frame erasure concealment (FEC) (542). The output of the FEC (542) is the erased frame vector for the previous frame k−1, i.e., [symbol] The erased frame vector from the FEC (542) is provided to multiplier B (550). The FEC (542) is explained in more detail below in the description of the second phase of the codebook search.

At multiplier B (550), the erased frame vector from the FEC (542) is multiplied by the prediction matrix A (i.e., prediction matrix 1) to produce the predicted value [symbol] , i.e., the erased frame mean-removed predicted vector. The predicted value [symbol] is then added to the mean vector (i.e., mean vector 1) at adder E (546) and the output vector of adder E (546) is then added to the quantized difference vector \hat{d}^{k} from the quantizer (522) at adder F (548) to produce the erased frame quantized vector [symbol] Then, the weighted erased frame squared error for the difference between the input vector xᵢ (from the transformer (502)) and the erased frame quantized vector [symbol] is determined at squarer B (554).

To determine the weighted erased frame squared error, a weighting wᵢ is applied to the erased frame squared error at squarer B (554). The weighting wᵢ is computed by the computer (508) as previously described and provided to squarer B (554). The weighted output \tilde{ε} (i.e., the weighted erased frame squared error) from squarer B (554) is

\tilde{ε}=Σᵢwᵢ(xᵢ− [symbol] )².

The weighted sum (536) produces the weighted sum of the weighted squared error from squarer A (538) and the weighted erased frame squared error from squarer B (544), i.e.,

αΣᵢwᵢ(xᵢ−\hat{x}ᵢ)²+(1−α)Σᵢwᵢ(xᵢ− [symbol] )²

In the first phase, the weighting value α used by the weighted sum (536) is set by the control (510) such that the weighted erased frame squared error contributes nothing to the weighted summation (e.g., is set to 1). Therefore, in the first phase, the weighted sum (536) produces the weighted squared error ε, i.e.,

ε=Σᵢwᵢ(xᵢ−\hat{x}ᵢ)²,

between the input vector xᵢ and the delayed quantized vector \hat{x}ᵢ. The output of the weighted sum (536) is stored at the control (510).

The above process is repeated for each codebook entry in codebooks 1 (e.g., in the second execution of the process, the quantizer (522) computes the difference between the difference vector d^{k} and the second entry in codebooks 1, etc.) with the resulting weighted squared error for each codebook entry stored at the control (510). Once the process has been repeated for all codebook entries in codebooks 1, the control (510) compares the stored measured errors for the codebook entries and identifies a number N of codebook entries with the minimum error (i.e., minimum distortion) for codebooks 1. More specifically, the measured error for each selected codebook entry is compared to a predetermined threshold and may be selected for searching in the second phase if the measured error is less than this predetermined threshold. Further, the maximum number of codebook entries that may be selected from a codebook has an upper bound of M as defined above. In one or more embodiments of the invention, M is five. The value of the predetermined threshold is selected such a codebook entry is selected when the quantized predictive parameters from that entry are perceptually equivalent to unquantized parameters of the frame. In one or more embodiments of the invention, the predetermined threshold is 67,000 for wideband speech signals and 62,000 for narrowband speech signals.

The control (510) then applies control signals to switch in via the switch (516) prediction matrix 2, mean vector 2, and to cause the second set of codebooks (i.e., codebooks 2) to be used to likewise measure the weighted squared error for each codebook entry of codebooks 2 as described above. Once the control (510) has identified the codebook entries with the minimum error for codebooks 2, in one or more embodiments of the invention, the controller (510) compares the measured errors of the two selected sets of codebook entries to pick the set that quantizes the difference vector d^{k} with the least distortion to be used in phase two of the codebook search technique. In other embodiments of the invention, the selected codebook entries from both codebooks may both be searched in the second phase.

In the second phase of the two phase codebook search technique, the LPC coefficients for the frame are quantized again with the assumption that the previous frame is erased. In the second phase, the control (510) first applies control signals to cause the set of codebooks that include the codebook entries selected in the first phase to be used in the quantizer (522) and to switch in via switch (516) the prediction matrix and mean vector from encoder storage (514) that is associated with the set of codebooks. For purposes of the description, the selection of entries from codebook 1 is assumed. The resulting LSF vector x^{k} from the transformer (502) is subtracted in adder A (518) by the selected mean vector μₓ (i.e., mean 1) and the resulting mean-removed input vector is subtracted in adder B (520) by a predicted value \check{x}^{k} for the current frame k. The predicted value \check{x}^{k} is the mean-removed quantized vector for the previous frame k−1 (i.e., \hat{x}^{k-1}−μₓ) multiplied by a known prediction matrix A (i.e., prediction matrix 1) at multiplier A (534). The process for supplying the mean-removed quantized vector for the previous frame to multiplier A (534) is described below.

The output of adder B (520) is a difference vector d^{k} for the current frame k. This difference vector d^{k} is applied to the multi-stage vector quantizer (MSVQ) (522). That is, the control (510) causes the quantizer (522) to compute the difference between the first entry of the selected codebook entries and the difference vector d^{k}. The output of the quantizer (322) is the quantized weighted difference vector [symbol] (i.e., error). The output of the quantizer (522) is the quantized difference vector \hat{d}^{k} (i.e., error). The predicted value \check{x}^{k} from multiplier A (534) is added to the quantized difference vector \hat{d}^{k} from the quantizer (522) at adder C (526) to produce a quantized mean-removed vector. The quantized mean-removed vector from adder C (526) is gated (530) to the frame delay A (532) so as to provide the mean-removed quantized vector for the previous frame k−1, i.e., \hat{x}^{k-1}−μₓ, to multiplier A (534).

The quantized mean-removed vector from adder C (326) is also added at adder D (328) to the selected mean vector μₓ (i.e., mean 1) to get the quantized vector \hat{x}^{k} Then, the weighted squared error for the difference between the input vector xᵢ (from the transformer (502)) and the quantized vector \hat{x}ᵢ is determined at squarer A (538) as described above.

The output of the frame delay A (532), i.e., the mean-removed quantized vector for the previous frame k−1, is also provided to the frame delay B (540), so as to provide the mean-removed quantized vector for the prior frame k−2, i.e., \hat{x}^{k-2}−μₓ, to the frame erasure concealment (FEC) (542). The output of the FEC (542) is the erased frame vector for the previous frame k−1, i.e., [symbol] More specifically, the FEC (542) estimates the erased frame vector for the previous frame k−1 using the frame erasure concealment technique of the decoder. That is, the vector of the previous frame is computed as if the quantized difference vector \hat{d}^{k-1} for that frame is corrupted. Frame erasure concealment techniques are known in the art and any such technique may be used in embodiments of the invention.

The erased frame vector from the FEC (542) is provided to multiplier B (550). At multiplier B (550), the erased frame vector from the FEC (542) is multiplied by the prediction matrix A (i.e., prediction matrix 1) to produce the predicted value [symbol] , i.e., the erased frame mean-removed predicted vector. The predicted value [symbol] is then added to the mean vector (i.e., mean vector 1) at adder E (546) and the output vector of adder E (546) is then added to the quantized difference vector \hat{d}^{k} from the quantizer (522) at adder F (548) to produce the erased frame quantized vector [symbol] Then, the weighted erased frame squared error for the difference between the input vector xᵢ (from the transformer (502)) and the erased frame quantized vector [symbol] is determined at squarer B (554) as previously described above.

In the second phase, the weighted sum (536) produces the weighted sum error ε̅ of the weighted squared error from squarer A (538) and the weighted erased frame squared error from squarer B (544), i.e.,

αΣᵢ(xᵢ−\hat{x}ᵢ)²+(1−α)Σᵢwᵢ(xᵢ− [symbol] )².

In the second phase, the weighting value α used by the weighted sum (536) is a predetermined weighting value set by the control (310) for the second phase. This predetermined weighting value may be selected as previously described above. The weighted sum error ε̅ from the weighted sum (536) is stored at the control (510).

The above phase two process is repeated for each codebook entry in the codebook entries selected in the first phase (e.g., in the second execution of the phase two process, the quantizer (522) computes the difference between the difference vector d^{k} and the second entry in the selected codebook entries, etc.) with the resulting weighted sum error ε̅ for each codebook entry stored at the control (510). Once the process has been repeated for all of the selected codebook entries, the control (510) compares the stored measured errors for the selected codebook entries and identifies the codebook entry with the minimum error. The control (510) then causes the set of indices for this codebook entry to be gated (524) out of the encoder as an encoded transmission of indices and a bit is sent out at the terminal (525) from the control (510) indicating from which prediction matrix/codebooks the indices were sent (i.e., codebooks 1 with mean vector 1 and prediction matrix 1 or codebook 2 with mean vector 2 and prediction matrix 2).

FIG. 6 shows a predictive decoder (600) for use with the predictive encoders of FIGS. 3 and 5 in accordance with one or more embodiments of the invention. At the decoder (600), the indices for the codebooks from the encoding are received at the quantizer (604) with two sets of codebooks corresponding to codebook set 1 and codebook set 2 in the encoder. The bit from the encoder terminal (325 of FIG. 3 or 525 of FIG. 5) selects the appropriate codebook set used in the encoder. The LSF quantized input is added to the predicted value at adder A (606) to get the quantized mean-removed vector. The predicted value is the previous mean-removed quantized value from the delay (610) multiplied at the multiplier (608) by the prediction matrix from storage (602) that matches the one selected at the encoder. Both prediction matrix 1 and mean value 1 and prediction matrix 2 and mean value 2 are stored in storage (602) of the decoder. The 1 bit from the encoder terminal (325 of FIG. 3 or 525 of FIG. 5) selects the prediction matrix and the mean value in storage (602) that matches the selected encoder prediction matrix and the mean value. The quantized mean-removed vector is added to the selected mean value at the adder B (612) to get the quantized LSF vector. The quantized LSF vector is transformed to LPC coefficients by the transformer (614).

As previously mentioned, the codebooks and the prediction matrices in some embodiments of the invention may be trained using a new method for initializing prediction matrices that takes erased frame distortion into account. In predictive quantization, a prediction matrix and the associated codebook are typically trained with a training set in an iterative fashion in which equation (2) above is minimized: for a given prediction matrix, the codebook is trained, and then, for a given trained codebook, the prediction matrix is trained. This process continues until both the prediction matrix and codebook converge. In one or more embodiments of the invention, a new method for initializing the prediction matrix is used that minimizes equation (6) instead of equation (2), i.e., that takes erased frame distortion into account.

In the prior art, the following process is typically employed to train a prediction matrix given the codebook. First, the total weighted squared error over the training set is computed as:

$$ɛ = {\sum }_{k = 0}^{M - 1} {\sum }_{n = 0}^{P - 1} {{w}_{n}^{k} ( {d}_{n}^{k} - {c}_{n}^{k} )}^{2} , \qquad ( 10 )$$

where wₙ^{k} is the weight for n^{th} coefficient of the vector in the k^{th} frame, dₙ^{k} is the distance vector for the n^{th} coefficient in the k^{th} frame whose formulation is given in (2), cₙ^{k} is the selected codebook entry for n^{th} coefficient for the k^{th} frame, and ε is total error in M frames for quantization of P coefficient vectors. To optimize the predictor coefficients (i.e., the prediction matrix) for the given codebook entries, the partial derivatives of each codebook entry with respect to ε are computed and equated to zero, and then, resulting equation is solved:

$$\frac{\partial ɛ}{\partial {β}_{i}} = - 2 {\sum }_{k = 0}^{M - 1} {w}_{n}^{k} ( {\hat{x}}_{l}^{k - 1} - {μ}_{l}^{x} ) [ ( {x}_{l}^{k} - {μ}_{l}^{x} ) - {β}_{l} ( {\hat{x}}_{l}^{k - 1} - {μ}_{l}^{x} ) - {c}_{l}^{k} ] = 0 , \qquad ( 11 )$$

where β₁ is I^{th} diagonal entry of the diagonal prediction matrix, A. When this equation is solved, β₁, is obtained as:

$${β}_{l} = \frac{{\sum }_{k = 0}^{M - 1} {w}_{n}^{k} ( {\hat{x}}_{l}^{k - 1} - {μ}_{l}^{x} ) [ ( {x}_{l}^{k} - {μ}_{l}^{k} ) - {c}_{l}^{k} ]}{{\sum }_{k = 0}^{M - 1} {{w}_{n}^{k} ( {\hat{x}}_{l}^{k - 1} - {μ}_{l}^{x} )}^{2}} . \qquad ( 12 )$$

At initialization, the same equations are used except that cₙ^{k} is set to zero. In this case (12) becomes

$${β}_{l} = \frac{{\sum }_{k = 0}^{M - 1} {w}_{n}^{k} ( {\hat{x}}_{l}^{k - 1} - {μ}_{l}^{x} ) ( {x}_{l}^{k} - {μ}_{l}^{x} )}{{\sum }_{k = 0}^{M - 1} {{w}_{n}^{k} ( {\hat{x}}_{l}^{k - 1} - {μ}_{l}^{x} )}^{2}} . \qquad ( 13 )$$

If there is large correlation between adjacent frames, β₁ is usually found to be very large, i.e., close to one. To have reasonable frame-erasure performance (i.e., to limit the error-propagation from an erased frame), β₁ is usually decreased artificially before the iterative training is started. However, this is usually a trial-by-error approach in which several different β₁'s are used to train different codebooks, and the prediction matrix/codebook pair which has the best overall clean-channel and frame-erasure performance is selected at the end.

Instead of using this trail-by-error approach, a new training method is used that extends the prior art equations to minimize not only the error-free distortion but also erased-frame distortion as well. By taking the erased-frame distortion into account, it is possible to find β₁ that are good for frame erasures without using a trial-by-error approach, i.e., without using any artificial adjustments to β₁.

In the new training method, dₙ^{k} in (10) is replaced by d̅ₙ^{k} defined in (6). In this case, (10) becomes

$$\begin{matrix}\begin{matrix}ɛ = {\sum }_{k = 0}^{M - 1} {\sum }_{n = 0}^{P - 1} {{w}_{n}^{k} ( {\overline{d}}_{n}^{k} - {c}_{n}^{k} )}^{2} \\ = {\sum }_{k = 0}^{M - 1} {\sum }_{n = 0}^{P - 1} {{w}_{n}^{k} ( {ad}_{k} + ( 1 - α ) {\tilde{d}}_{k} - {c}_{n}^{k} )}^{2} \\ = {\sum }_{k = 0}^{M - 1} {\sum }_{n = 0}^{P - 1} {w}_{n}^{k} [ α ( ( {x}_{n}^{k} - {μ}_{n}^{k} ) - {β}_{n} ( {\hat{x}}_{n}^{k - 1} - {μ}_{n}^{k} ) ) + \\ { ( 1 - α ) ( ( {x}_{n}^{k} - {μ}_{n}^{k} ) - {β}_{n} ( {\tilde{\hat{x}}}_{n}^{k + 1} - {μ}_{n}^{k} ) ) - {c}_{n}^{k} ]}^{2} \\ = {\sum }_{k = 0}^{M - 1} {\sum }_{n = 0}^{P - 1} {{w}_{n}^{k} [ α ( {x}_{n}^{′} - {β}_{n} {\hat{x}}_{n}^{′ k - 1} ) + ( 1 - α ) ( {x}_{n}^{′ k} - {β}_{n} {\tilde{\hat{x}}}_{n}^{′ k - 1} ) - {c}_{n}^{k} ]}^{2} ,\end{matrix} \\ where & ( 14 ) \\ {x}_{n}^{′ k} = {x}_{n}^{k} - {μ}_{n}^{k} \\ {\hat{x}}_{n}^{′ k - 1} = {\hat{x}}_{n}^{k - 1} - {μ}_{n}^{k} \\ {\tilde{\hat{x}}}_{n}^{′ k - 1} = {\tilde{\hat{x}}}_{n}^{k - 1} - {μ}_{n}^{k} . & ( 15 )\end{matrix}$$

Minimization of ε with respect to β₁ gives the following equation:

$$- 2 {α}^{2} {\sum }_{k = 0}^{M - 1} {w}_{l}^{k} {\hat{x}}_{l}^{′ k - 1} [ {x}_{l}^{′ k} - {β}_{l} {\hat{x}}_{l}^{′ k - 1} ] + 2 α {\sum }_{k = 0}^{M - 1} {w}_{l}^{k} {\hat{x}}_{l}^{′ k - 1} {c}_{l}^{k} … \frac{\partial ɛ}{\partial {β}_{l}} = - 2 ( 1 - α ) α {\sum }_{k = 0}^{M - 1} {w}_{l}^{k} [ {\hat{x}}_{l}^{′ k - 1} [ {x}_{l}^{′ k} - {β}_{l} {\tilde{x}}_{l}^{′ k - 1} ] + {\tilde{\hat{x}}}_{n}^{′ k - 1} [ {x}_{l}^{′ k} - {β}_{l} {\hat{x}}_{l}^{′ k - 1} ] ] … - 2 {α ( 1 - α )}^{2} {\sum }_{k = 0}^{M - 1} {w}_{l}^{k} {\tilde{\hat{x}}}_{l}^{′ k - 1} [ {x}_{l}^{′ k} - {β}_{l} {\tilde{\hat{x}}}_{l}^{′ k - 1} ] + 2 ( 1 - α ) {\sum }_{k = 0}^{M - 1} {w}_{l}^{k} {\hat{x}}_{l}^{′ k - 1} {c}_{l}^{k} = 0. \qquad ( 16 )$$

The solution of this equation gives β₁ as:

$${β}_{l} = \frac{\begin{matrix}{\sum }_{k = 0}^{M - 1} {w}_{l}^{k} ( {α}^{2} {\hat{x}}_{l}^{′ k - 1} {x}_{l}^{′k} + ( 1 - α ) α [ {\hat{x}}_{l}^{′ k - 1} + {\hat{x}}_{n}^{′ k - 1} ] {x}_{l}^{′ k} + \\ {( 1 - α )}^{2} {\tilde{\hat{x}}}_{n}^{′ k - 1} {x}_{l}^{′ k} - α {\hat{x}}_{l}^{′ k - 1} {c}_{l}^{k} - ( 1 - α ) {\tilde{\hat{x}}}_{n}^{′ k - 1} {c}_{l}^{k} )\end{matrix}}{{\sum }_{k = 0}^{M - 1} \begin{matrix}{w}_{l}^{k} ( {α}^{2} {\hat{x}}_{l}^{′ k - 1} {\hat{x}}_{l}^{′ k - 1} + \\ 2 ( 1 - α ) α {\hat{x}}_{l}^{′ k - 1} {\tilde{\hat{x}}}_{n}^{′ k - 1} + {( 1 - α )}^{2} {\tilde{\hat{x}}}_{n}^{′ k - 1} {\tilde{\hat{x}}}_{n}^{′ k - 1} )\end{matrix}} \qquad ( 17 )$$

Note that when α is set to one, (16) becomes (12) as expected. For training initialization (i.e., when cₙ^{k} is set to zero), (17) becomes

$${β}_{l} = \frac{{\sum }_{k = 0}^{M - 1} \begin{matrix}{w}_{l}^{k} ( {α}^{2} {\hat{x}}_{l}^{′ k - 1} {x}_{l}^{′ k} + \\ ( 1 - α ) α [ {\hat{x}}_{l}^{′ k - 1} + {\tilde{\hat{x}}}_{n}^{′ k - 1} ] {x}_{l}^{′ k} + {( 1 - α )}^{2} {\tilde{\hat{x}}}_{n}^{′ k - 1} {x}_{l}^{′ k} )\end{matrix}}{{\sum }_{k = 0}^{M - 1} {w}_{l}^{k} ( {α}^{2} {\hat{x}}_{l}^{′ k - 1} {\hat{x}}_{l}^{′ k - 1} + 2 ( 1 - α ) α {\hat{x}}_{l}^{′ k - 1} + {( 1 - α )}^{2} {\tilde{\hat{x}}}_{n}^{′ k - 1} {\tilde{\hat{x}}}_{n}^{′ k - 1} )} . \qquad ( 18 )$$

By controlling α, it is possible to determine the relative importance of error-free performance and frame-erasure performance. Once this relative importance is determined, the optimum predictor coefficient can be found in least squares sense. Determining β₁ in one step eliminates the need for a trial-by-error approach.

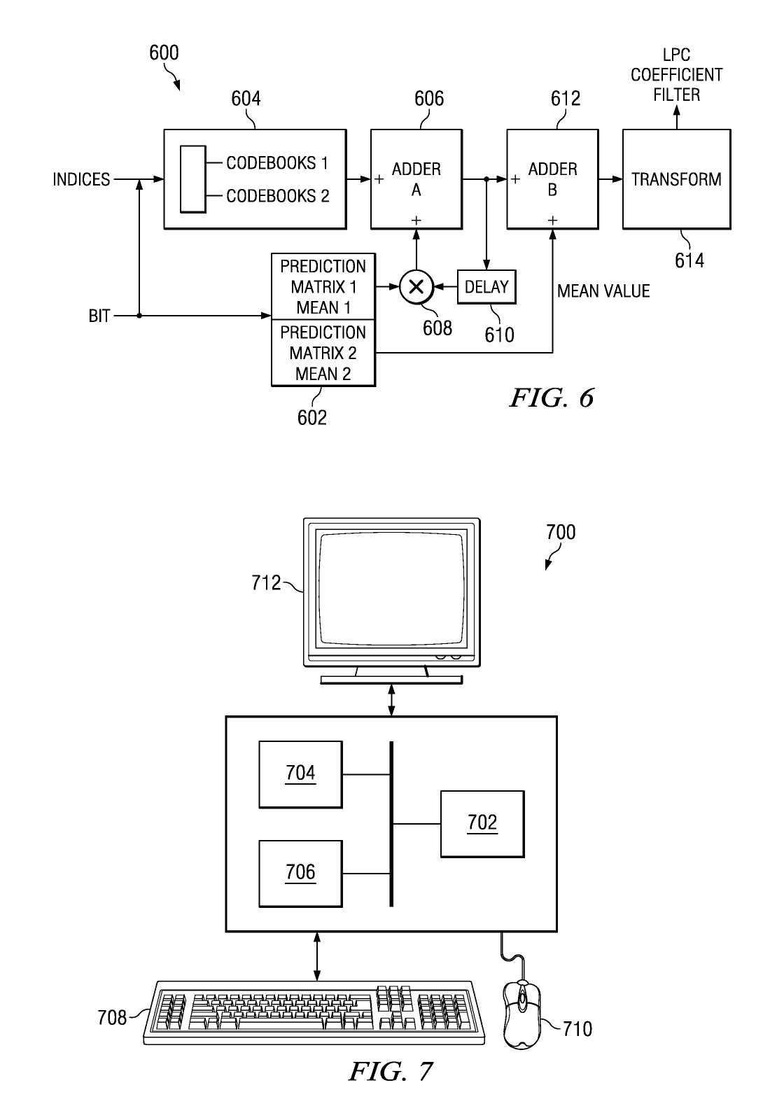

Embodiments of the methods and encoders described herein may be implemented on virtually any type of digital system (e.g., a desk top computer, a laptop computer, a handheld device such as a mobile phone, a personal digital assistant, an MP3 player, an iPod, etc.). For example, as shown in FIG. 7, a digital system (700) includes a processor (702), associated memory (704), a storage device (706), and numerous other elements and functionalities typical of today's digital systems (not shown). In one or more embodiments of the invention, a digital system may include multiple processors and/or one or more of the processors may be digital signal processors. The digital system (700) may also include input means, such as a keyboard (708) and a mouse (710) (or other cursor control device), and output means, such as a monitor (712) (or other display device). The digital system (700) may be connected to a network (714) (e.g., a local area network (LAN), a wide area network (WAN) such as the Internet, a cellular network, any other similar type of network and/or any combination thereof) via a network interface connection (not shown). Those skilled in the art will appreciate that these input and output means may take other forms.

Further, those skilled in the art will appreciate that one or more elements of the aforementioned digital system (700) may be located at a remote location and connected to the other elements over a network. Further, embodiments of the invention may be implemented on a distributed system having a plurality of nodes, where each portion of the system and software instructions may be located on a different node within the distributed system. In one embodiment of the invention, the node may be a digital system. Alternatively, the node may be a processor with associated physical memory. The node may alternatively be a processor with shared memory and/or resources. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. For example, instead of an AMR-WB type of CELP, a G.729 or other type of CELP may be used in one or more embodiments of the invention. Further, the number of codebook/prediction matrix pairs may be varied in one or more embodiments of the invention. In addition, in one or more embodiments of the invention, other parametric or hybrid speech encoders/encoding methods may be used with the techniques described herein (e.g., mixed excitation linear predictive coding (MELP)). The quantizer may also be any scalar or vector quantizer in one or more embodiments of the invention. Accordingly, the scope of the invention should be limited only by the attached claims.

It is therefore contemplated that the appended claims will cover any such modifications of the embodiments as fall within the true scope and spirit of the invention.

What is claimed is:

1. A method for predictive encoding comprising:
computing quantized predictive frame parameters for an input frame;
recomputing the quantized predictive frame parameters wherein a previous frame is assumed to be erased and frame erasure concealment is used; and
encoding the input frame based on the results of the computing and the recomputing.

2. The method of claim 1, wherein
computing the quantized predictive parameters further comprises identifying a number of codebook entries that produce lowest distortion of the quantized predictive parameters; and
recomputing the quantized predictive frame parameters further comprises selecting a codebook entry of the number of codebook entries that produces lowest distortion of the quantized predictive parameters.

3. The method of claim 2, wherein identifying the number of codebook entries further comprises comparing the weighted squared errors of all entries in a codebook.

4. The method of claim 2, wherein the number of codebook entries is predetermined, and wherein a predetermined weighting value used in computing distortion of the quantized predictive parameters is set according to relative importance of frame erasure performance and clean channel performance.

5. The method of claim 2, wherein
identifying the number of codebook entries further comprises identifying codebook entries which produce quantized predictive parameters that are perceptually equivalent to unquantized parameters of the input frame, and wherein
a predetermined weighting value used in computing distortion of the quantized predictive parameters is set according to one selected from a group consisting of maximizing frame erasure performance and relative importance of frame erasure performance and clean channel performance.

6. The method of claim 2, wherein recomputing the quantized predictive frame parameters further comprises:
estimating an erased frame vector for the prior frame using the frame erasure concealment; and
computing an erased frame mean-removed predicted vector for the input frame using the erased frame vector.

7. The method of claim 6, wherein recomputing the quantized predictive frame parameters further comprises:
computing an erased frame difference vector between a mean-removed unquantized parameter vector of the input frame and the erased frame mean-removed predicted vector; and
computing a weighted difference vector using a difference vector, the erased frame difference vector, and a predetermined weighting value, wherein the difference vector is the difference between the mean-removed unquantized parameter vector and a mean-removed predicted vector of the input frame.

8. The method of claim 6, wherein recomputing the quantized predictive frame parameters further comprises:
for each codebook entry of the number of codebook entries:
computing a weighted squared error between an unquantized parameter vector of the input frame and a quantized parameter vector of the input frame;
computing an erased frame weighted squared error between the unquantized parameter vector and an erased frame quantized vector for the input frame; and
computing a weighted sum of the weighted squared error and the erased frame weighted squared error using a predetermined weighting value.

9. The method of claim 8, wherein selecting a codebook entry of the number of codebook entries that produces the lowest distortion further comprises:
selecting the codebook entry of the number of codebook entries with a smallest weighted sum.

10. The method of claim 1, wherein a prediction matrix and an associated codebook used in the computing and the recomputing are trained using predictor coefficients computed using the frame erasure concealment.

11. A predictive encoder for encoding input frames, wherein encoding an input frame comprises:
computing quantized predictive frame parameters for the input frame;
recomputing the quantized predictive frame parameters wherein a previous frame is assumed to be erased and frame erasure concealment is used; and
encoding the input frame based on the results of the computing and the recomputing.

12. The encoder of claim 11, wherein encoding an input frame further comprises:
computing the quantized predictive parameters further comprises identifying a number of codebook entries that produce the lowest distortion of the quantized predictive parameters; and
recomputing the quantized predictive frame parameters further comprises selecting a codebook entry of the number of codebook entries that produces lowest distortion of the quantized predictive parameters.

13. The encoder of claim 12, wherein identifying the number of codebook entries further comprises comparing the weighted squared errors of all entries in a codebook.

14. The encoder of claim 12, wherein the number of codebook entries is predetermined, and wherein a predetermined weighting value used in computing distortion of the quantized predictive parameters is set according to relative importance of frame erasure performance and clean channel performance.

15. The encoder of claim 12, wherein
identifying the number of codebook entries further comprises identifying codebook entries which produce quantized predictive parameters that are perceptually equivalent to unquantized parameters of the input frame, and wherein
a predetermined weighting value used in computing distortion of the quantized predictive parameters is set according to one selected from a group consisting of maximizing frame erasure performance and relative importance of frame erasure performance and clean channel performance.

16. The encoder of claim 12, wherein recomputing the quantized predictive frame parameters further comprises:
estimating an erased frame vector for the prior frame using the frame erasure concealment; and
computing an erased frame mean-removed predicted vector for the input frame using the erased frame vector.

17. The encoder of claim 16, wherein recomputing the quantized predictive frame parameters further comprises:
computing an erased frame difference vector between a mean-removed unquantized parameter vector of the input frame and the erased frame mean-removed predicted vector; and
computing a weighted difference vector using a difference vector, the erased frame difference vector, and a predetermined weighting value, wherein the difference vector is the difference between the mean-removed unquantized parameter vector and a mean-removed predicted vector of the input frame.

18. The encoder of claim 16, wherein
recomputing the quantized predictive frame parameters further comprises:
for each codebook entry of the number of codebook entries:
computing a weighted squared error between an unquantized parameter vector of the input frame and a quantized parameter vector of the input frame;
computing an erased frame weighted squared error between the unquantized parameter vector and an erased frame quantized vector for the input frame; and
computing a weighted sum of the weighted squared error and the erased frame weighted squared error using a predetermined weighting value; and
selecting a codebook entry of the number of codebook entries that produces the lowest distortion further comprises:
selecting the codebook entry of the number of codebook entries with a smallest weighted sum.

19. The encoder of claim 11, wherein a prediction matrix and an associated codebook used in the computing and the recomputing are trained using predictor coefficients computed using the frame erasure concealment.

20. A digital system comprising a predictive encoder for encoding input frames), wherein encoding an input frame comprises:
computing quantized predictive frame parameters for the input frame;
recomputing the quantized predictive frame parameters wherein a previous frame is assumed to be erased and frame erasure concealment is used; and
encoding the input frame based on the results of the computing and the recomputing.
